(19) United States
(12) Patent Application Publication
(10) Pub. No.: US 2008/0297834 A1
(43) Pub. Date: Dec. 4, 2008

(54) INFORMATION PROCESSING APPARATUS AND METHOD, PROGRAM, AND PRINT SYSTEM

(75) Inventor: Naohiro Yamaguchi, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/057,333

(22) Filed: Mar. 27, 2008

(30) Foreign Application Priority Data
May 31, 2007 (JP) 2007-146102

(51) Int. Cl. G06F 15/00

(52) U.S. Cl. 358/1.15

(57) ABSTRACT

In outputting printed products in a sorted state, an additional print job should also be output in a sorted state. For this purpose, when information representing the necessity of additional print of a printed product is input to a variable data printing application, a VD obtaining unit obtains a target record. A VDP generation unit generates a VDP job based on the record. Information for specifying the processing order of the additional print job is determined on the basis of the processing order of print jobs already sent to the print device and the information of the additional print job.

### BACKGROUND OF THE INVENTION

1. Field of the Invention

The present invention relates to an information processing apparatus and method, and a print device and print system, all of which execute, for example, variable printing.

2. Description of the Related Art

Along with the increase in the process speed and image quality of printing devices, a printing method called print on demand (to be referred to as POD hereinafter) has been put into practice. One form of POD is a technique called variable printing which composites variable data representing print contents with template data created in advance, thereby printing different contents having a common format for every predetermined unit. This technique enables more efficient information delivery by, for example, using user specific data stored in an existing database as variable data and creating and distributing different documents for the users. When variable data is obtained from a database, one document is created for each record in the database. A print job generated by compositing a template and variable data in a variable printing system will be called a variable data print (to be referred to as VDP hereinafter) job.

Output products of variable printing are often bound as a book or sent as mail. A variable printing system used for this purpose causes an application for executing variable printing to generate a VDP job by sorting variable data (records) in accordance with post-press processing such as bookbinding, folding, or enclosing executed by a post-press unit. This function will be referred to as sorted variable printing. In the variable printing system, the variable printing application sorts records designated as a print target using their specific field as a key. Then, the variable printing application generates a VDP job by compositing each record with a template. When the records are sorted before VDP job generation, printed products are also output and stacked on the discharge unit in the sorted order. This makes it possible to reduce cost in the post-press processing or a post-process such as conveyance and improve productivity.

For example, assume that a printed product is postal matter, and the postal code, address, and addressee of a destination are composited with a template as variable data in each VDP job. In the collection and delivery station of each post office, postal matters collected from postboxes are sorted in accordance with the postal code, address, and addressee written on them and delivered. If the postal matter is sorted using, for example, the postal code as a key and then printed, assuming the assortment, output with sorted postal codes is implemented. This reduces the mail processing cost and also contributes to shortening the sending time. The above-described sorted variable printing function is useful in such a case.

Some variable printing systems have a function of discharging a printed product to a discharge tray called a sample tray different from a normally used discharge tray. This function allows an operator to inspect the printed product discharged to the sample tray and confirm whether print is normally performed. Inspection is done not only by the operator who visually confirms a printed product discharged to the sample tray but also by a system which automatically inspects a printed product by pattern matching using a CCD camera. If the operator or inspection device confirms a printed product and finds a problem, reprint can be performed by inputting job information such as a job name or job ID to the variable data printing application.

There is a printed product management system which monitors whether printed products are printed in order by reading individual information from each printed product created by a variable printing system and specifying, on the basis of the contents of the individual information, the ordinal number of the printed product in a predetermined print order (e.g., Japanese Patent Laid-Open No. 2003-001965). This printed product management system selectively outputs book-bound printed products printed in order and those printed out of order to different lines. This prevents sorted printed products from including a printed product reprinted due to a print error in no particular order. Hence, the reprint does not impede cost reduction and productivity improvement by sorting.

Assume that variable printing is executed by sorted variable printing, and some printed products are reprinted. To add the reprinted products to the group of sorted printed products, it is necessary to specify a position in the sorted printed products to which each reprinted product should be output. Then, the operator inserts the reprinted products to the specified positions manually or using a device called a collator. Then, post-processing can be performed.

As described above, when the sorted variable printing system reprints some of printed products, the reprinted products and the already printed products need to be merged. To do this, the operator must search for the insertion position of each reprinted product, and this hinders productivity improvement. This problem becomes more serious especially as the print amount increases.

### SUMMARY OF THE INVENTION

The present invention has been made in consideration of the above-described prior art, and has as its object to provide a print control apparatus and method, a print device, and a print system, all of which can reduce the printed product merging operation and contribute to productivity improvement.

In order to achieve the above object, according to the present invention, there is provided a n information processing apparatus connected to a print device for processing a print job, comprising:

a job sender which sends, to the print device, print jobs generated from different variable data in an order of sorting the different variable data using a designated sort key; and

a determiner which, in sending an additional print job to be added to the sent print jobs, determines ordinal information for specifying a processing order of the additional print job using information representing a processing order of the print jobs sent by the job sender and information of the additional print job,

wherein the job sender sends, to the print device, the additional print job and the ordinal information determined by the determiner.

According to the present invention, it is possible to reduce the operation of merging sorted printed products and additional printed products and contribute to improvement of productivity of a print process that requires sorting of printed products.

Further features of the present invention will become apparent from the following description of exemplary embodiments with reference to the attached drawings.

### BRIEF DESCRIPTION OF THE DRAWINGS

FIG. 1 is a block diagram showing a system arrangement according to the first embodiment;

FIGS. 2A and 2B are flowcharts illustrating the print process of a print system according to the first embodiment;

FIGS. 3A, 3B, and 3C are flowcharts illustrating the print process of the print system according to the first embodiment;

FIGS. 4A and 4B are tables showing the records of the print system according to the first embodiment;

FIG. 5 is a table showing an example of a sorting process result of the record group of the print system according to the first embodiment;

FIG. 6 is a conceptual view of the queuing process of the print system according to the first embodiment;

FIG. 7 is a conceptual view of the VDP job sorting process of the print system according to the first embodiment;

FIG. 8 is a conceptual view of the VDP job sorting process of the print system according to the first embodiment;

FIG. 9 is a flowchart illustrating a process of receiving a job with designation in the print system according to the first embodiment;

FIGS. 10A, 10B, and 10C are flowcharts illustrating the reprint process of the print system according to the first embodiment;

FIG. 11 is a functional block diagram showing an example of a system arrangement according to the second embodiment of the present invention;

FIGS. 12A and 12B are flowcharts illustrating the print process of a print system according to the second embodiment;

FIG. 13 is a flowchart illustrating the record sorting process of the print system according to the second embodiment;

FIG. 14 is a flowchart illustrating the record bundling process of the print system according to the second embodiment;

FIG. 15 is a flowchart illustrating the VDP job receiving process using a job list in the print system according to the second embodiment;

FIGS. 16A, 16B, 16C, and 16D are flowcharts illustrating the reprint process of a print and bookbinding system according to the second embodiment;

FIG. 17 is a flowchart illustrating the VDP job sorting process of the print system according to the second embodiment;

FIG. 18 is a block diagram showing the arrangement of an information processing apparatus applicable to the print system according to the embodiment; and

FIG. 19 is a view for explaining a detailed example of the first embodiment.

### DESCRIPTION OF THE EMBODIMENTS

### First Embodiment

In sorted variable printing, if a group of records having the same sort key value exists, the records can be arranged in any order in the record group. In this embodiment, if a reprint record that requires reprint is present, and an unprinted record which is unprinted and has the same sort key value as the reprint record is present, the reprint record is reprinted immediately after the unprinted record. This allows the output of printed products in the sorted order, including the reprint record, and allows omission of the manual merging operation after print. A system arrangement and processing procedure according to this embodiment will be described below.

<System Arrangement>

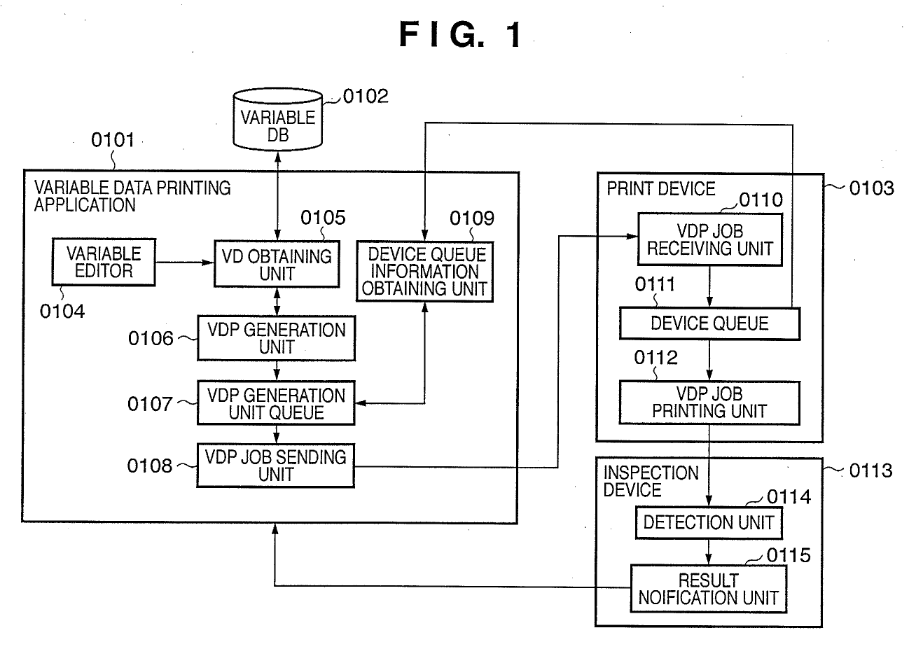

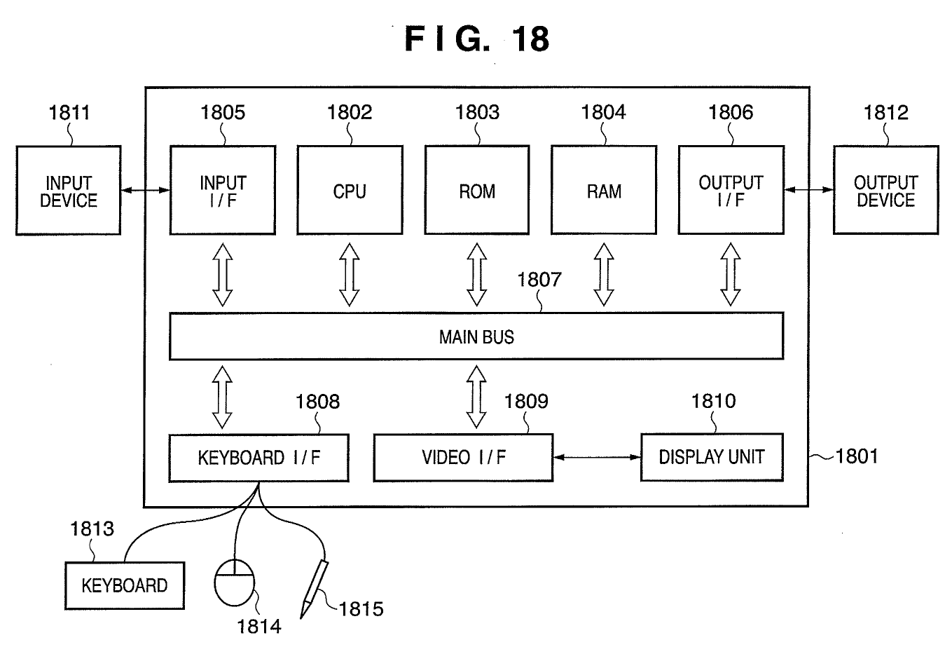

FIG. 1 is a functional block diagram of a variable printing system according to the first embodiment. Referring to FIG. 1, a variable data printing application 0101 executes variable printing. The variable data printing application 0101 includes a variable editor 0104, variable data obtaining unit 0105, VDP job generation unit 0106, VDP generation unit queue 0107, VDP job sending unit 0108, and device queue information obtaining unit 0109. The variable data printing application 0101 is executed by a computer shown in FIG. 18 and causes the computer to function as a print control apparatus.

The variable editor 0104 creates template data (to be referred to as variable template) for variable printing by using an edit UI provided in the variable data printing application.

A variable database 0102 holds record information serving as the contents of VDP jobs. The variable data obtaining unit 0105 communicates with the variable database 0102 and obtains the record information of a designated record from the variable database 0102. In this embodiment, the variable data obtaining unit 0105 also sorts obtained records using a designated sort key before VDP job generation. That is, the variable data obtaining unit 0105 also functions as a sorter. The VDP job generation unit 0106 generates composite data by compositing a variable template with record information and generates a print job (to be referred to as a VDP job) from the composite data. The VDP generation unit queue 0107 manages VDP jobs, generated by the variable data printing application 0101, in accordance with the VDP job state of a device queue 0111. The VDP job generation unit 0106 registers generated VDP jobs in the VDP generation unit queue 0107 in accordance with the order of records sorted by the variable data obtaining unit 0105. To add a new VDP job (additional print job) to VDP jobs already sorted and sent, the VDP job generation unit 0106 generates the new VDP job.

The VDP job sending unit 0108 corresponds to a job sender which sends a VDP job to a print device 0103. The print device 0103 registers received VDP jobs in the device queue and processes them in a first-in first-out order. The print device 0103 leaves VDP jobs which are waiting for execution or being executed in the device queue. An executed VDP job is deleted from the device queue. However, upon receiving ordinal information representing the registration order in the device queue together with a VDP job, the print device 0103 registers the VDP job corresponding to the ordinal information at a position in the device queue designated by the ordinal information. That is, the print device 0103 inserts the VDP job that is an additional print job into the device queue. Ordinal information represents, as an additional print job registration position in the device queue, a possible registration position of composite data associated with an additional print job (to be referred to as additional composite data) among a plurality of composite data which are sorted together with the additional composite data. The position of the additional composite data is represented as a “possible” registration position because the plurality of records having the same sort key value are sorted, although the order can change, and it is impossible to always specify one position.

The device queue information obtaining unit 0109 obtains the state of a VDP job (to be referred to as a VDP job state) queued in the device queue 0111 by the print device 0103 and transfers the VDP job state to the VDP generation unit queue 0107. The device queue information obtaining unit 0109 corresponds to a device queue information obtainer.

The print device 0103 includes a VDP job receiving unit 0110, device queue 0111, and VDP job printing unit 0112. The VDP job receiving unit 0110 receives VDP jobs sent from the VDP job sending unit 0108 and stores them in the device queue 0111. The device queue 0111 stores and manages the VDP jobs. The VDP job printing unit 0112 obtains the VDP jobs stored in the device queue 0111 and prints them. VDP jobs to be received include a VDP job with a designation, which has number information (also referred to as ordinal information) that designates a position in the device queue, and a VDP job without position designation.

An inspection device 0113 includes a detection unit 0114 and a result notification unit 0115. The detection unit 0114 inspects a printed product printed by the VDP job printing unit 0112 and determines whether the printed product has an error. The result notification unit 0115 notifies the variable data printing application 0101 of an error detected by the detection unit 0114. The sent information is reprint information representing the necessity of reprint.

The variable data printing application 0101 is executed by a computer having an interface to the print device 0103. More specifically, the variable data printing application 0101 is a computer program and is stored as a program file in a storage such as a hard disk. When the program file is loaded to a memory and executed by a processor, the constituent elements of the variable data printing application 0101 shown in FIG. 1 are implemented.

FIG. 18 is a block diagram showing the arrangement of the computer (i.e., information processing apparatus). Referring to FIG. 18, a CPU 1802 controls an entire information processing apparatus 1801 via a main bus 1807. The CPU 1802 also controls, via an input I/F (interface) 1805, an input device 1811 connected outside the information processing apparatus 1801. Examples of the input device are an image scanner, a storage device, another information processing apparatus connected via a network, and a facsimile apparatus connected via a telephone line. The CPU 1802 also controls, via an output I/F 1806, an output device 1812 connected outside the information processing apparatus 1801. Examples of the output device are a print device such as a printer or multifunctional peripheral, a monitor, another information processing apparatus connected via a network, and a facsimile apparatus connected via a telephone line. The CPU 1802 also executes a series of processes including image input, image processing, color conversion, and image output control in accordance with instructions input from an input unit such as a keyboard 1813 via a keyboard interface 1808. The input unit includes a pointing device 1814 and a pen 1815. The CPU 1802 also controls, via a video I/F (interface) 1809, a display unit 1810 which displays image data input from the input device 1811, or image data created using the input unit.

A ROM 1803 stores various control programs which execute various kinds of control of the CPU 1802. The CPU 1802 loads, in a RAM 1804, an OS and other control programs including a control program to implement the present invention and executes the programs. The RAM 1804 also functions as various work areas or temporary save area to be used to execute the control programs. Additionally, a VRAM (not shown) for temporarily holding image data input from the input device 1811, or image data created using the keyboard 1813, pointing device 1814, or pen 1815 is formed.

<Flowcharts of Processes of First Embodiment>

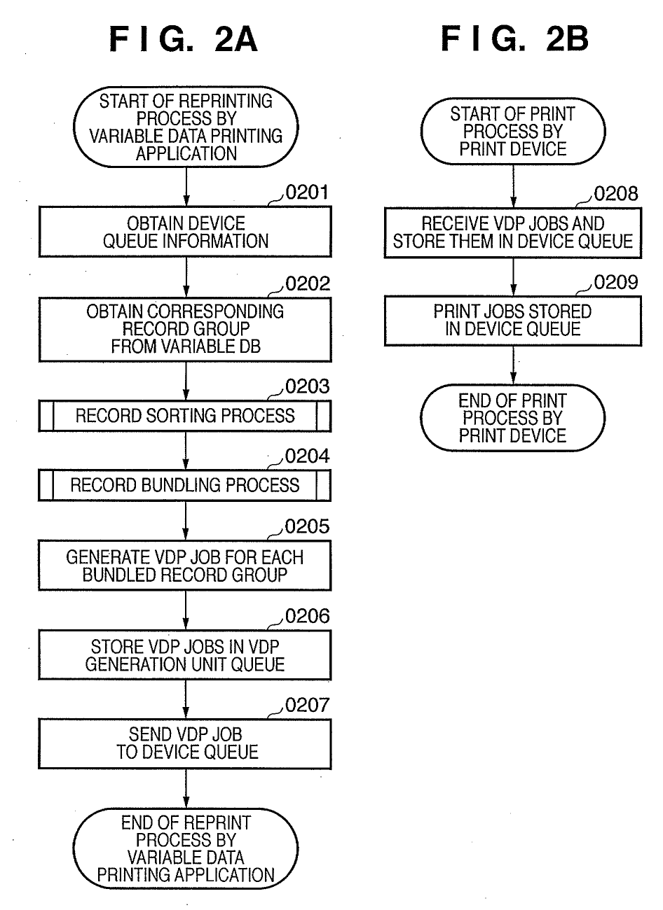

FIGS. 2A and 2B are flowcharts illustrating the print process of the print system according to the first embodiment. In the print process, the VDP job generation unit 0106 of the variable data printing application 0101 generates a VDP job, and the print device 0103 prints it when no existing VDP job exists in the VDP generation unit queue 0107 and device queue 0111. The variable data printing application 0101 executes steps 0201 to 0207 in FIG. 2A, and the print device 0103 executes steps 0208 and 0209 in FIG. 2B.

In step 0201, the device queue information obtaining unit 0109 obtains information (device queue information) about a VDP job in the device queue 0111. The device queue information includes, for example, the job IDs of VDP jobs included in the device queue and their order. If no VDP job is registered in the device queue, the device queue information represents that the device queue is empty. When the variable data printing application 0101 saves VDP jobs, the device queue and the VDP jobs in it can be reproduced on the basis of obtained job IDs. When the record ID of a record in the database, which is used to generate a VDP job, is also saved together with the VDP job in association with the job ID, a position in the queue where the VDP job should be inserted can be specified in, for example, job insertion to be described later.

In step 0202, the variable data obtaining unit 0105 obtains, from the variable database 0102, records with a print designation by the user.

In step 0203, the variable data obtaining unit 0105 sorts the records obtained in step 0202 by a designated sorting method using a designated field in the records as a sort key. The sort key is designated in accordance with, for example, the procedure of post-press processing after print. It is possible to designate a plurality of sort keys as needed. When a plurality of sort keys are designated, the keys have priority orders. If there are a plurality of records having the same value for a sort key of a certain priority order, the records are sorted by the sort key of the next priority order. Such sorting is executed using the sort keys in descending order of priority orders. The sorting method includes designation of sorting order such as descending order or ascending order.

In step 0204, the variable data obtaining unit 0105 bundles the records sorted in step 0203 on the basis of the property values included in the records. As the property value, for example, a field value designated as a sort key is employed. Bundling records based on the property value indicates, for example, grouping records having the same property value. For example, the sort key of the highest priority order is employed as the property value to bundle the records. Since records having the same property value are arranged consecutively by sorting, grouping can be implemented by specifying the boundary between adjacent records having different property values. In this case, a record group between specified boundaries is a grouped record group. The order of sorted records does not change upon grouping.

In step 0205, the VDP job generation unit 0106 generates a VDP job from each record group bundled in step 0204. That is, one VDP job is generated from one record group. A record group bundled in step 0204 may include only one record depending on the sort key. One VDP job is an execution unit in the print device 0103. Each VDP job is registered in the device queue 0111.

In step 0206, the VDP job generation unit 0106 registers the VDP jobs generated in step 0205 in the VDP generation unit queue 0107. The queue registers only the VDP job IDs. Print data as the contents of a VDP job can be saved in another area in association with the job ID. In this case, the VDP job contains print data as its entity. The VDP generation unit queue 0107 is not necessarily processed in a first-in first-out order. The VDP generation unit queue 0107 can be sorted, as will be described later. In this case, the VDP jobs are output in the sorting order.

In step 0207, the VDP job sending unit 0108 sends the VDP jobs stored in the VDP generation unit queue 0107 to the VDP job receiving unit 0110 of the print device 0103. The VDP jobs are sent in the generation order. Each sent VDP job is assigned identification information representing “sent” or “unsent” and saved in the VDP generation unit queue 0107.

On the other hand, the print device 0103 executes the operations in steps 0208 and 0209. In step 0208, the VDP job receiving unit 0110 stores the received VDP jobs in the device queue 0111. In step 0209, the VDP job printing unit 0112 prints the VDP jobs stored in the device queue 0111, and the process is ended.

<Record Sorting Process>

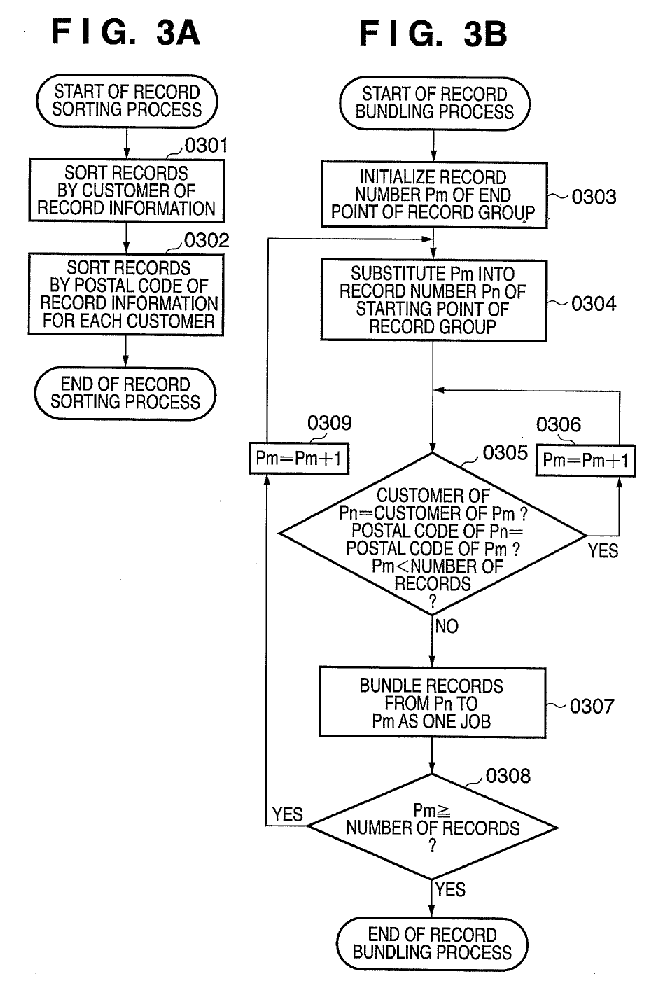

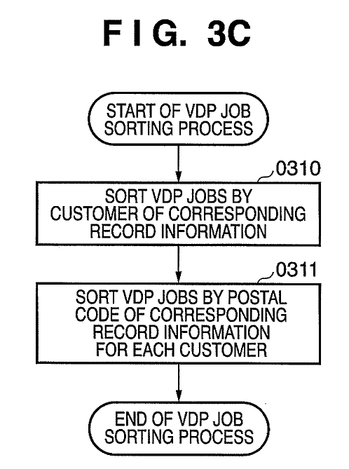

FIGS. 3A, 3B, and 3C are flowcharts illustrating a record information sorting process by the VD obtaining unit 0105 of the variable data printing application 0101 of the system shown in the block diagram of FIG. 1, and a VDP job sorting process in the VDP generation unit queue 0107. The record information sorting process (0203) by the VD obtaining unit 0105 of the variable data printing application 0101 will be described below.

In step 0301, the VD obtaining unit 0105 sorts all records in accordance with a customer field included in the records. That is, the records are sorted using the customer field as the sort key of the highest priority order. In step 0302, the VD obtaining unit 0105 sorts the record group of each customer, which is a result of sorting in step 0301, in accordance with a postal code field. That is, the records are sorted using the postal code field as the sort key of the next priority order. In this case, the sorting result by the sort key of the higher priority order is maintained. More specifically, in this example, a plurality of records having the same value in the customer field are sorted in the record group using the postal code field as a sort key. When all records are sorted, the variable data obtaining unit finishes the record sorting process.

An example in which the records are sorted using two sort keys, customer and postal code, has been described. However, any other field can be used as a sort key. The records may be sorted using three or more sort keys or one sort key.

<Record Bundling Process>

A record bundling process (0204) by the VD obtaining unit 0105 of the variable data printing application 0101 will be described below. In step 0303, the VD obtaining unit 0105 reads out and saves records designated as a print target. The VD obtaining unit 0105 initializes a variable Pm by substituting 1 into it. The variable Pm represents the record number of the end point of a record group bundled as one VDP job. In step 0304, the VD obtaining unit 0105 substitutes Pm into a variable Pn representing the record number of the starting point of the record group bundled as one VDP job.

In step 0305, the VD obtaining unit 0105 compares the properties of the record Pm with those of the record Pm and determines whether they are identical in order to process records having the same postal code as one job for each customer. In this case, the properties are customer and postal code, i.e., the fields used as sort keys. If the records Pm and Pn have the same customer and same postal code, and Pm is smaller than the number of records to be printed, the process advances to step 0306. If the records Pm and Pn have different customers or different postal codes, or Pm is equal to or larger than the number of records to be printed, the process advances to step 0307.

In step 0306, the VD obtaining unit 0105 increments Pm by one and refers to the next record. The process returns to step 0305. In step 0307, the VD obtaining unit 0105 generates a job by bundling the record group from the record Pn to record Pm. To bundle the records, it is only necessary to discriminate bundled records. Hence, pieces of identification information (e.g., record numbers) of records belonging to a bundle of records are saved in association with the bundle.

In step 0308, the VD obtaining unit 0105 determines whether the value of Pm is equal to or larger than the number of records to be printed. If Pm is equal to or larger than the number of records to be printed, the record bundling process is ended. If Pm is smaller than the number of records to be printed, the process advances to step 0309. In step 0309, the VD obtaining unit 0105 increments Pm by one. Then, the process returns to step 0304.

This procedure enables the bundling of sorted records of each record group having the same sort key value.

<VDP Job Sorting Process>

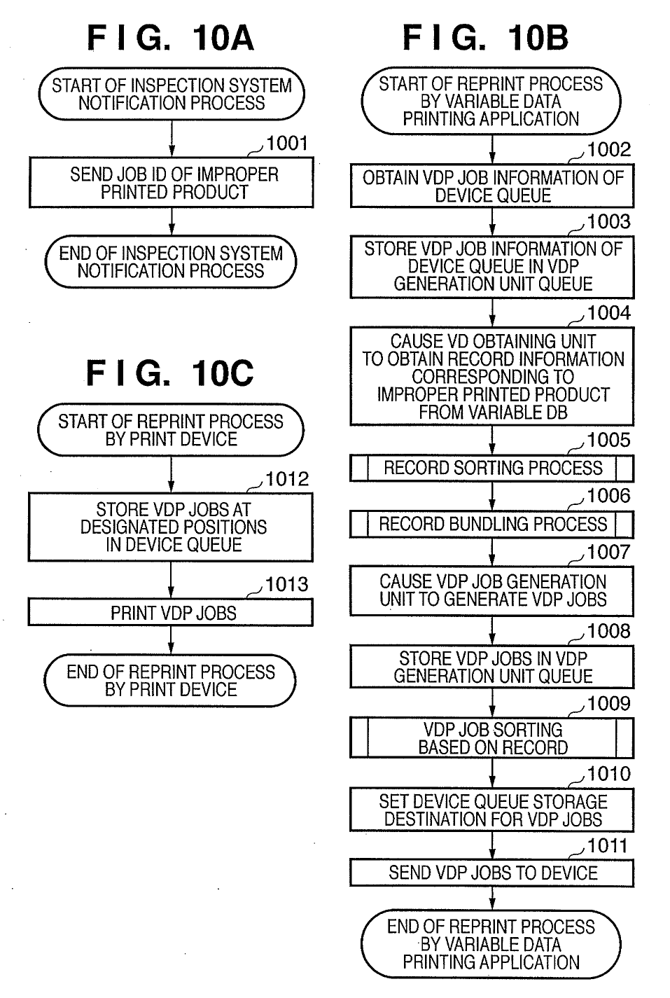

The VDP job sorting process in the VDP generation unit queue 0107 of the variable data printing application 0101 will be described below. This process is unnecessary as far as the sorted records are processed in that order. However, when a new job generated from a record in no particular order is to be added to the VDP generation unit queue, the process needs to be executed. For example, this process is necessary in a reprint process shown in FIGS. 10A, 10B, and 10C.

In step 0310, the VDP generation unit queue 0107 sorts VDP jobs using, as a key, customer information contained in record information in generating each VDP job. The process advances to step 0311. In step 0311, the VDP generation unit queue 0107 sorts the jobs sorted in step 0310 using, as a key, a postal code contained in the record information of each VDP job.

It is difficult to read out a used record value from a generated VDP job. Hence, to facilitate sorting, the job ID and sort key value of each VDP job are separately saved in association with each other. One VDP job is generated by the bundling process from composite data created by compositing records having the same sort key value with a template. Hence, a job ID and a sort key value (if a plurality of sort keys are used, a set of sort key values) can be associated with each other in a one-to-one correspondence. The VDP jobs are sorted using the associated sort key. If VDP jobs are generated in the record sorting order and registered in the VDP generation unit queue in the generation order, VDP job sorting is unnecessary. VDP job sorting is necessary when VDP jobs are already registered in the VDP generation unit queue, and a VDP job is to be additionally inserted into them.

The VDP jobs registered in the VDP generation unit queue are sent to the print device 0103. At this time, the device queue information obtained in step 0201 is referred to, and the VDP jobs registered in the device queue are not sent. For VDP jobs that are not registered in the device queue, if a VDP job already registered in the device queue exists, the VDP job is sent together with number information (ordinal information) representing the position of the VDP job in the device queue. For the remaining VDP jobs that are not registered in the device queue, they are sent to the print device without number information (ordinal information) Whether a VDP job is already registered in the device queue can be determined by collating job IDs in the device queue with those in the VDP generation unit queue.

<Example of Result of Record Sorting Process>

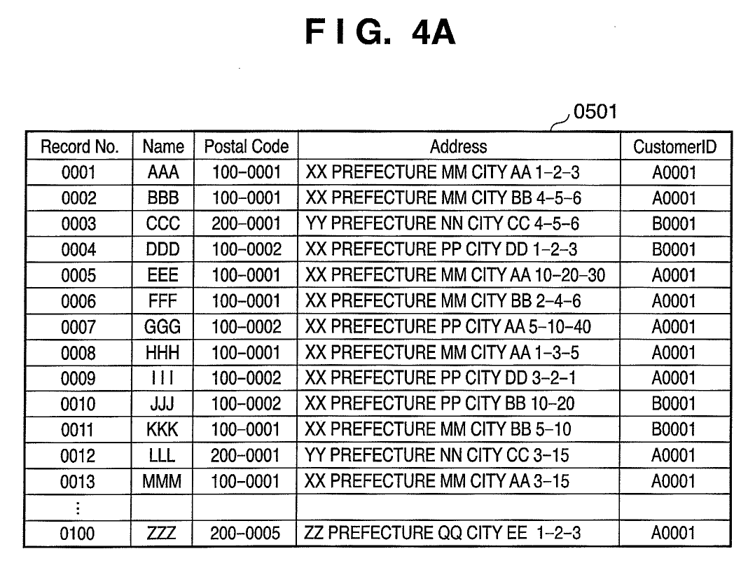

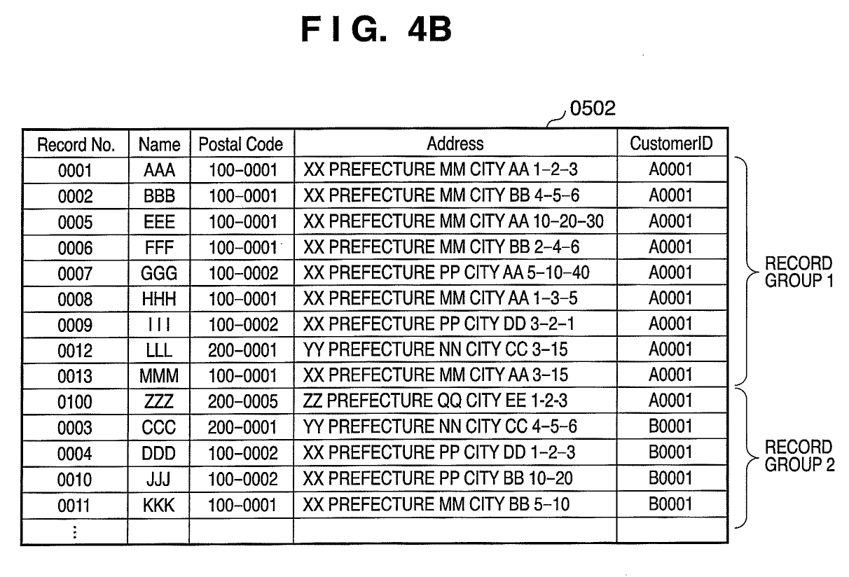

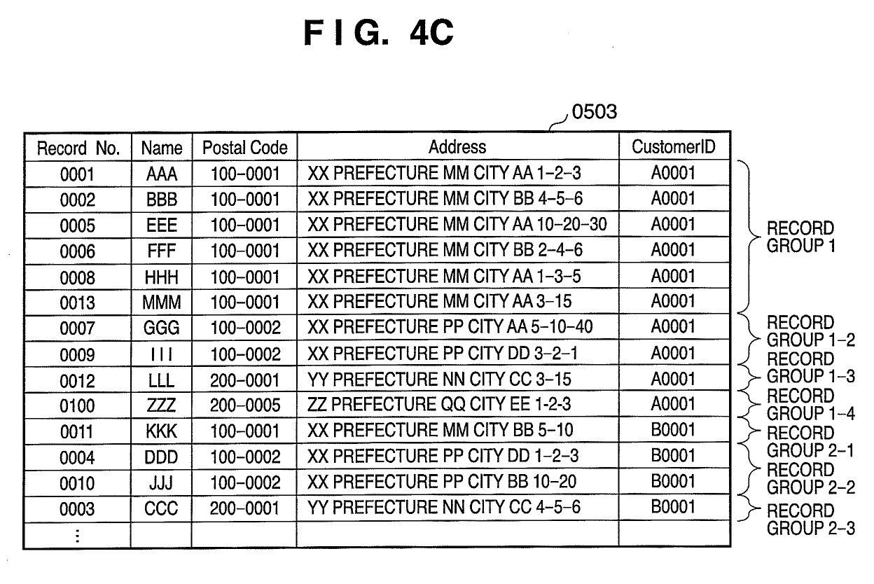

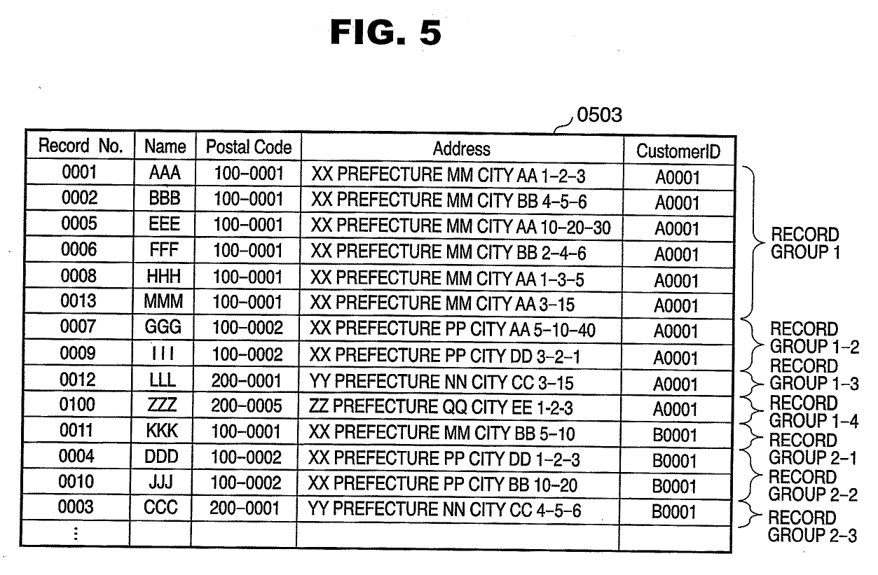

FIGS. 4A, 4B, and 5 are tables showing examples of results obtained by causing the VD obtaining unit 0105 of the variable data printing application 0101 to sort and bundle record groups from the variable database 0102 using a plurality of field properties of the records as keys.

A table 0501 in FIG. 4A represents a record group designated by the user and obtained by the VD obtaining unit 0105 from the variable database 0102. Each record of the record group 0501 has, as fields, Record No. representing a record number, Name representing a name, Postal Code representing a postal code, Address representing an address, and customer name representing a customer ID. The records in the table 0501 are sorted in accordance with record numbers.

A table 0502 in FIG. 4B is obtained by causing the VD obtaining unit 0105 to sort the record group of the table 0501 in the order of Customer IDs (i.e., customer names). The VD obtaining unit 0105 sorts records having the same customer name into one record group.

A table 0503 in FIG. 5 is obtained by causing the VD obtaining unit 0105 to further sort the records included in each record group of the same customer name, which are sorted as shown in the table 0502, in the order of Postal Codes. After sorting, the VD obtaining unit 0105 bundles records having the same customer name and same or similar postal codes into one group. The VDP job generation unit 0106 generates composite data by compositing each of the records belonging to one bundled record group with a template, and generates one VDP job from the generated composite data.

As a result of sorting, the records are divided into seven record groups 1-1, 1-2, 1-3, 1-4, 2-1, 2-2, and 2-3, as shown in the table 0503. The first number of a numeral representing a record group indicates a group by a customer name. The second number next to a hyphen indicates a group by a postal code in a group sorted by a customer name.

<Conceptual View of Queuing Process>

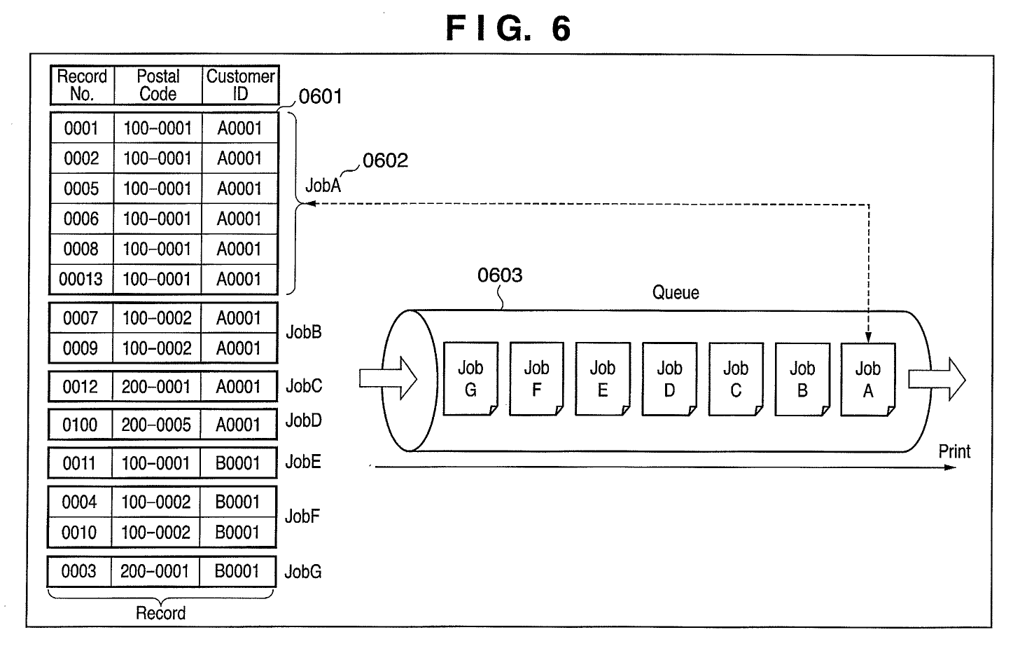

FIG. 6 is a view showing a state in which the VD obtaining unit 0105 bundles a plurality of records having the same property value into a record group, and VDP jobs generated from the record groups are stored in the VDP generation unit queue 0107.

A table 0601 represents a record group having the same property combination (customer name=A0001, and postal code=100-0001), which is formed by sorting records obtained by the VD obtaining unit 0105 in accordance with the customer name and postal code. Fields other than the sort keys and record numbers are omitted. Job A 0602 is a VDP job generated for the record group 0601 by the VDP job generation unit 0106. Jobs generated in the same way are stored in a VDP generation unit queue 0603. The order of storage is the same as the order of sorting by the VD obtaining unit 0105. The VDP generation unit queue 0603 receives each job from the left side of FIG. 6 and outputs it to the right side for print. The Job A 0602 is located at the top upon sorting. Hence, the Job A 0602 is located at the rightmost position in the VDP generation unit queue 0603.

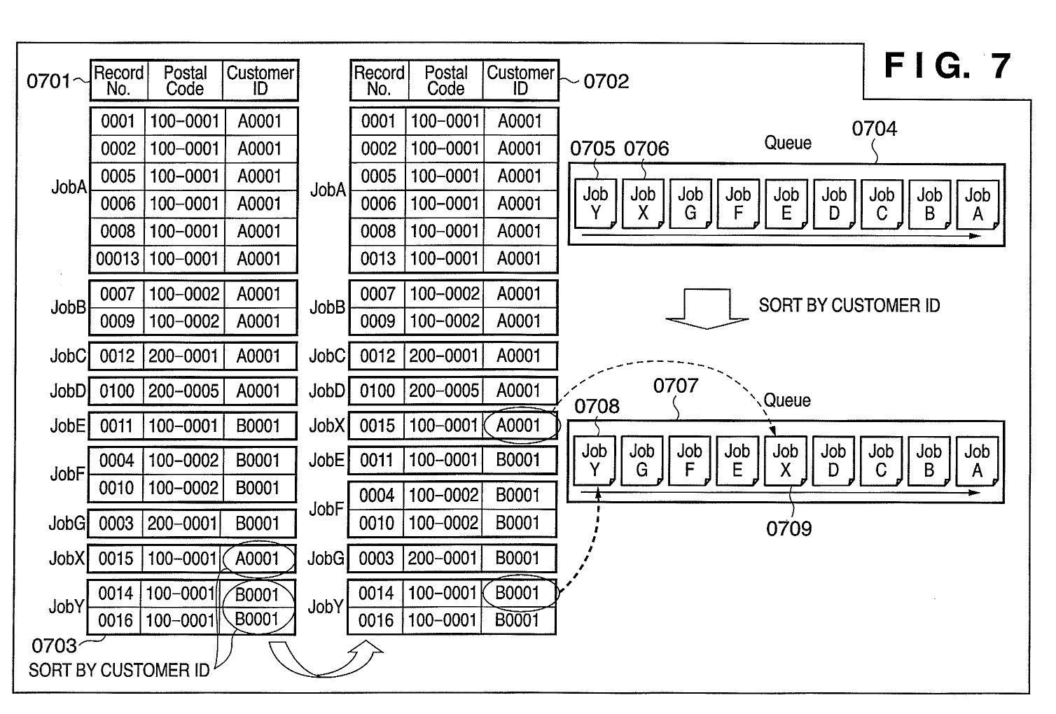

FIG. 7 is a view showing a sorting result of the jobs in the VDP generation unit queue 0107 described with reference to FIG. 6. The VDP generation unit queue 0107 adds record information 0703 of reprint jobs to the end of a record information group 0701 and sorts the record groups in accordance with the customer name (customer ID). A record information group 0702 indicates the sorting result of the record groups. Note that three records of Record Nos. 0014, 0015, and 0016 undergo reprint.

Assume that a print job corresponding to a new record is added to the queue 0603 in FIG. 6. The VDP job to be added is a reprint job for reprinting an already printed VDP job. Reprint will be described later with reference to FIG. 10A and the like. A queue 0704 schematically indicates a state in which reprint jobs are added to the VDP generation unit queue 0107. The record of Record No. 0015 has a customer ID “A0001” and postal code “100-0001”. Hence, this record should be contained in the job A. However, since the job A is already generated, an independent VDP job X is generated. The records of Record Nos. 0014 and 0016 have the same sort key values as those of a job E. However, since the job E is already generated, a VDP job Y is generated by bundling the two records.

The jobs in the queue 0704 correspond to the record information group 0701. A reprint job X 0706 and a reprint job Y 0705 are added to the end of the queue 0704. The VDP generation unit queue sorts the queue 0704 on the basis of the customer names of the record information of the VDP job, as described above. Then, a state indicated by a queue 0707 is obtained. More specifically, the record state in the table 0702 is reflected so that the reprint VDP jobs in the queue move to positions 0708 and 0709.

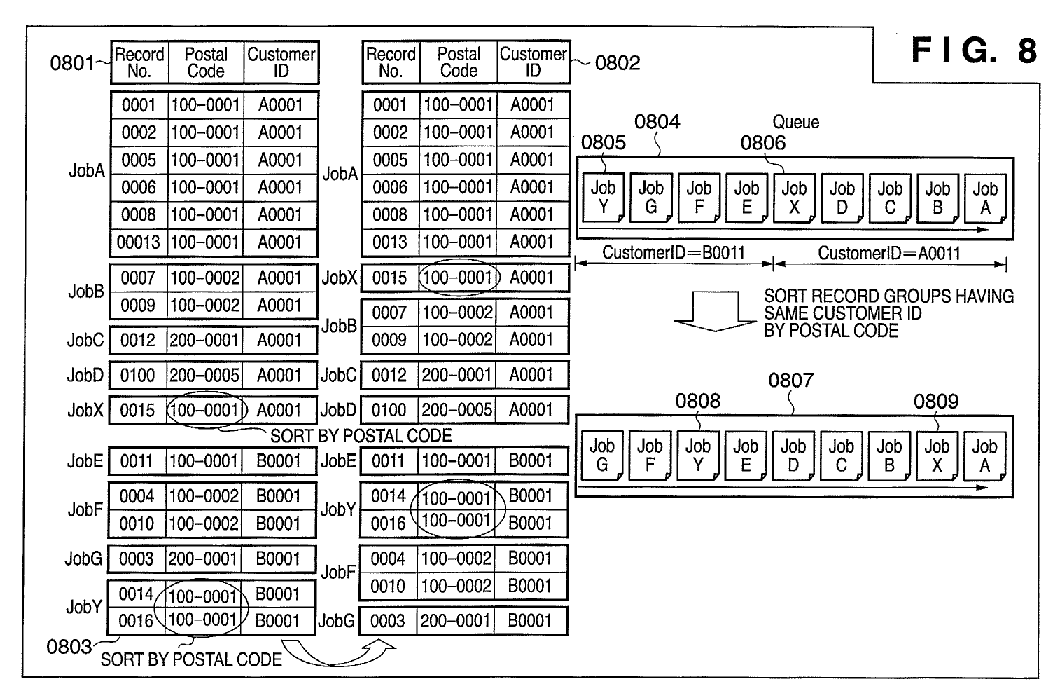

FIG. 8 is a view showing a process result obtained by causing the VDP generation unit queue to further sort the records sorted in FIG. 7 on the basis of the postal codes. A record information group 0801 is formed by sorting the record information group in accordance with the customer name, as in the table 0702. A record information group 0802 is a result obtained by sorting the record information group 0801 in accordance with the postal code. A queue 0804 indicates a VDP job state of the VDP generation unit queue corresponding to the record information group. A queue 0807 indicates a state in which the VDP jobs corresponding to the records having the same customer name are sorted in accordance with the postal code. As a result, the job X moves to a position immediately after the job A, and the job Y moves to a position immediately after the job E. More specifically, the jobs X and Y are located immediately after the VDP jobs which should have include them. In this way, additional print jobs can be sorted in the job queue in correspondence with the sorting result of the records to be printed by the additional print jobs.

<Job Receiving Process>

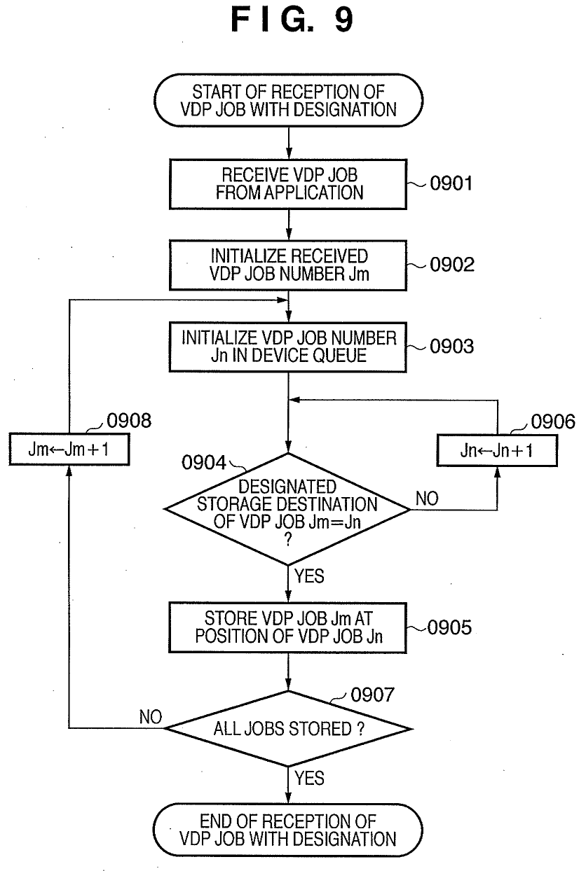

FIG. 9 is a flowchart illustrating a process of receiving a VDP job with a storage destination designation in the VDP job receiving unit 0110 of the print device 0103. A storage destination designation is added to a job as number information or ordinal information. A VDP job without a storage destination designation is processed in steps 0208 and 0209 in FIG. 2B.

In step 0901, the VDP job receiving unit 0110 receives VDP jobs from the VDP job sending unit 0108 of the variable data printing application 0101. Each VDP job has number information (or called ordinal information) representing the storage position of the job in the device queue 0111 in addition to print data. When the VDP job receiving unit 0110 receives all jobs, the process advances to step 0902.

In step 0902, the VDP job receiving unit 0110 initializes a variable Jm representing the number of each received VDP job to 0. The process advances to step 0903. In step 0903, the VDP job receiving unit 0110 initializes a variable Jn representing a VDP job number in the device queue 0111 to 0. The process advances to step 0904. In step 0904, the VDP job receiving unit 0110 compares the job number Jn in the device queue 0111 with the storage destination number in the device queue 0111 designated by the VDP job Jm. If the VDP job number Jn matches the storage destination number designated by the VDP job Jm, the process advances to step 0905. If the VDP job number Jn does not match the storage destination number, the process advances to step 0906.

In step 0905, the VDP job receiving unit 0110 stores the VDP job Jm at the position of the VDP job Jn in the device queue 0111. The process advances to step 0907. In step 0906, the VDP job receiving unit 0110 increments the VDP job number Jn in the device queue 0111 by one. The process returns to step 0904.

In step 0907, the VDP job receiving unit 0110 determines whether all received jobs are stored. If storage is completed, the process of receiving a VDP job with designation is ended. If storage is not completed, the process advances to step 0908.

In step 0908, the VDP job receiving unit 0110 increments the VDP job number Jm by one. The process returns to step 0903.

<Reprint Process>

FIGS. 10A, 10B, and 10C are flowcharts illustrating the reprint process of the print and bookbinding system according to the first embodiment. In step 1001, the inspection device 0113 finds an improper printed product and notifies the variable data printing application 0101 of identification information (print request ID) to request print of the printed product. In the process shown in FIGS. 10A to 10C, a print request ID corresponds to a record number. A print request ID specifying method will be described. The inspection device receives the job ID of a printed job to be inspected from the print device and obtains, from the variable data printing application 0101, the number of paper sheets necessary for one record of each job ID. The inspection device specifies a print request ID using the job ID and the number of paper sheets necessary for one record. The print request ID specifying method will be described using a detailed example. Assume that the inspection device inspects 10 printed products of a print job (“job ID: A”) printed by the print device and determines that the sixth sort key is improper. The inspection device receives, from the variable data printing application 0101, information representing that “job ID: A” uses two paper sheets per record. Hence, the inspection device can specify that the sixth printed product corresponds to the third record of the print job of “job ID: A”. That is, the inspection device sends “third record of job ID: A” to the variable data application as a print request ID.

In step 1002, upon receiving the notification, the device queue information obtaining unit 0109 of the variable data printing application 0101 obtains VDP job information stored in the device queue 0111 of the print device 0103. In step 1003, the device queue information obtaining unit 0109 stores, in the VDP generation unit queue 0107, the VDP job information in the device queue 0111 obtained in step 1002. In step 1004, the VD obtaining unit 0105 obtains, from the variable database 0102, a record corresponding to the print request ID of the improper printed product sent to the variable data printing application 0101 in step 1001.

In step 1005, the VD obtaining unit 0105 sorts the records obtained in step 1004 on the basis of the customer name of variable printing and the postal code representing the destination of the printed product, which are the field properties of the records. The process in step 1005 is the same as in FIG. 3A. In step 1006, the VD obtaining unit 0105 selects records having the same field value from the records sorted in step 1005 and bundles them. The process in step 1006 is the same as in FIG. 3B. In step 1007, the VDP job generation unit 0106 generates VDP jobs from the record groups bundled in step 1006. In step 1008, the VD obtaining unit 0105 stores the VDP jobs generated in step 1007 in the VDP generation unit queue 0107.

In step 1009, the VDP generation unit queue 0107 sorts all VDP jobs in the queue using, as keys, the customer of variable printing and the postal code in the record information corresponding to each VDP job. This process is the same as in FIG. 3C. In step 1010, the VDP generation unit queue 0107 sets ordinal information representing a storage destination in the device queue 0111 for each VDP job generated in step 1007 by referring to the storage order of the sorted VDP jobs. Note that the VDP generation unit queue 0107 also functions as a determiner because it determines ordinal information to specify the processing order of the jobs generated in step 1007. That is, the VDP generation unit queue 0107 sets the ordinal information using the information of additional print jobs (additional print job information) and information representing the processing order of the sent print jobs. The process advances to step 1011. In step 1011, the VDP job sending unit 0108 sends, to the VDP job receiving unit 0110 of the print device 0103, each VDP job for which the ordinal information as the storage destination is set in step 1008. The ordinal information need only specify the processing order of the VDP jobs generated in step 1007 and need not always represent a detailed processing order. Except a detailed processing order, the ordinal information may be expressed as, for example, “process next to job of job ID: 2”.

In step 1012, the VDP job receiving unit 0110 stores the received VDP jobs at designated positions in the device queue 0111. The process advances to step 1013. In step 1013, the VDP job printing unit 0112 prints the VDP jobs stored in the device queue 0111 in the order of storage in the queue, and the reprint process is ended.

In the flowchart in FIG. 10B, the variable data printing application obtains the job information of the device queue and specifies the ordinal information of the jobs generated in step 1007. However, the present invention is not limited to this. To specify the ordinal information without obtaining the job information of the device queue, the variable data printing application stores the sent job IDs and the processing order of the jobs. The jobs generated in step 1007 and the stored sent jobs are sorted, thereby deciding a job ID which should be processed before a job generated in step 1007.

The flowcharts in FIGS. 10A to 10C assume reprint. However, they are also applicable to a process other than reprint. For example, jobs that are newly added can be output in an appropriate order by using the process shown in FIGS. 10A to 10C.

In the above-described manner, record groups including reprint records are sorted. VDP jobs generated from the records are merged with the current device queue in the sorting order of the records. This obviates manual merging of printed products.

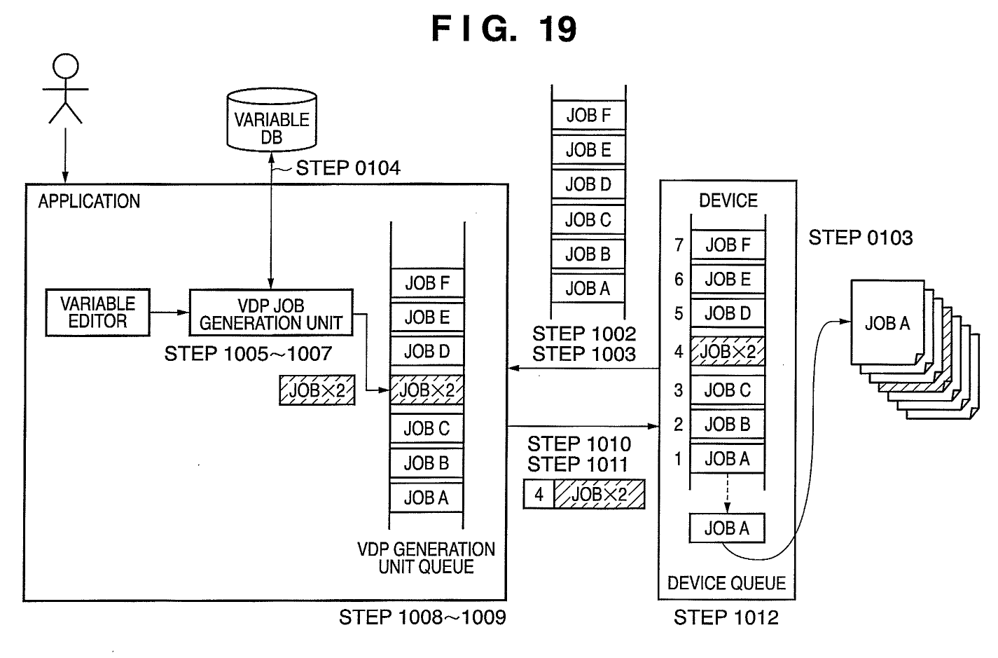

The process in FIGS. 10A to 10C will be described here in detail with reference to FIG. 19.

In FIG. 19, the process starts after the second record of the job X is printed, and an improper state is detected.

The detection unit notifies the variable data printing application 0101 that the print result of the second record of the job X is improper.

Upon receiving the notification, the device queue information obtaining unit 0109 of the variable data printing application 0101 obtains device queue information 1901 from the device and stores the information in the VDP generation unit queue 0107 (1002 and 1003). The device queue information 1901 represents that jobs A to F should be printed in order.

The VD obtaining unit 0105 obtains, from the variable database, a record corresponding to the second record of the job X of the improper printed product (1004).

The VD obtaining unit 0105 sorts the obtained records (1005). However, since the number of reprint target records is one in FIG. 19, the process in step 1005 is skipped.

The VD obtaining unit 0105 bundles the records using the sorting result (1006) and generates additional print jobs (1007). In FIG. 19, a print job based on the reprint target record is generated. The additional print job to be reprinted is represented as a job X₂ in FIG. 19.

The VD obtaining unit 0105 stores the generated reprint job in the VDP generation unit queue 0107 (1008). At this time, the VDP generation unit queue 0107 stores the job information of the jobs A to F in this order. The job X₂ of the reprint target is stored next to the job F.

The VDP generation unit queue 0107 sorts the VDP jobs in the queue (1009). For example, if information corresponding to a sort key of the job C matches that of the job X₂, the VDP generation unit queue 0107 sorts the jobs to process the job X₂ next to (or before) the job C.

The VDP generation unit queue 0107 sets the storage destination of the job X₂ of the reprint target on the basis of the sorting process executed in step 1009 (1010) and sends the job X₂ to the device. In FIG. 19, the VDP generation unit queue 0107 sets to store the job X₂ at the fourth position.

The device stores the job X₂ at the designated storage destination, i.e., the fourth position in the device queue and prints the job.

In executing reprint, a newly generated VDP job can be inserted into the device queue or not. For example, assume that a reprint target record is the last record in the VDP job to which the record belongs. In this case, when an error is detected from the printed product of the record, the process of the next VDP job may have already started. In this state, even when the reprint job is inserted into the device queue, the jobs are not output in a correct sorting order. Hence, the reprinted product must be output lastly or separately from normal printed products so that the user can manually merge it later. To do this, the inspection device 0113 may operate in the following way upon determining a printed product as an error in inspection. The inspection device determines whether the print device is currently processing a print job to which the record of the printed product with the detected error belongs. If the process is progressing, the inspection device notifies the variable data printing application 0101 that the print job should be reprinted immediately. If the process is already ended, the inspection device notifies the variable data printing application 0101 that the print job should be reprinted separately from the job group that is currently being output. Upon receiving the notification for immediate reprint, the variable data printing application 0101 merges the reprint job with the device queue in accordance with the above-described procedure. This enables the addition of, for example, an additional print job to the end of the device queue if job merging with the device queue is undesirable. This also applies to the second embodiment.

### Second Embodiment

In the process described in the first embodiment, the variable data printing application sorts and bundles records using the customer information and postal code of each record. The queue provided in the variable data printing application manages VDP jobs. In the process of the second embodiment to be described below, a variable data printing application sorts and bundles records using the print format information and reference content information of each record and the process restriction information of the print system. A queue for managing VDP jobs is provided in a job manger different from the variable data printing application. A description of processes common to the first embodiment will sometimes be omitted.

<System Arrangement>

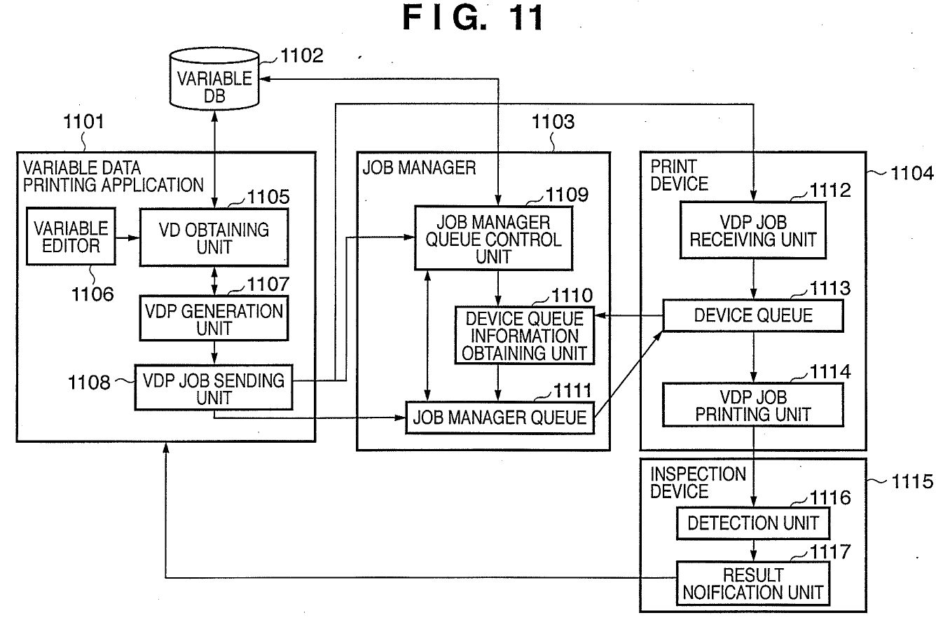

FIG. 11 is a functional block diagram of a variable printing system according to the second embodiment. A variable data printing application 1101 executes variable printing. The variable data printing application 1101 includes a variable data obtaining unit 1105, variable editor 1106, VDP job generation unit 1107, and VDP job sending unit 1108. A variable database 1102 holds record information serving as the contents of VDP jobs. The variable data obtaining unit 1105 communicates with the variable database 1102 and obtains arbitrary record information. In the variable editor 1106, a user creates a template using an edit UI. The VDP job generation unit 1107 generates a VDP job by combining a variable template with record information. The VDP job sending unit 1108 sends VDP jobs generated by the VDP job generation unit 1107 to a print device 1104.

A job manager 1103 is an application which manages jobs. The job manager 1103 includes a job manager queue control unit 1109, device queue information obtaining unit 1110, and job manager queue 1111. The job manager queue control unit 1109 causes the device queue information obtaining unit 1110 to obtain information of a device queue 1113 of the print device 1104. The job manager queue control unit 1109 also obtains data from the variable database 1102 and stores the data in the job manager queue 1111, or manages the job manager queue 1111. The device queue information obtaining unit 1110 obtains the VDP job state of the device queue 1113 from the print device 1104 and sets it in the job manager queue 1111. The job manager queue 1111 obtains VDP jobs generated by the variable data printing application 1101 and the VDP job state of the device queue 1113 and manages the states of the VDP jobs.

The print device 1104 includes a VDP job receiving unit 1112, device queue 1113, and VDP job printing unit 1114. The VDP job receiving unit 1112 receives a VDP job sent from the VDP job sending unit 1108 and stores it in the device queue 1113.

The device queue 1113 stores and manages the VDP jobs. The VDP job printing unit 1114 obtains the VDP jobs stored in the device queue 1113 and prints them.

An inspection device 1115 includes a detection unit 1116 and a result notification unit 1117. The detection unit 1116 inspects a printed product printed by the VDP job printing unit 1114 and determines whether the printed product has an error. The result notification unit 1117 notifies the variable data printing application 1101 of an error detected by the detection unit 1116.

<Flowcharts of Processes of Second Embodiment>

(Print Process)

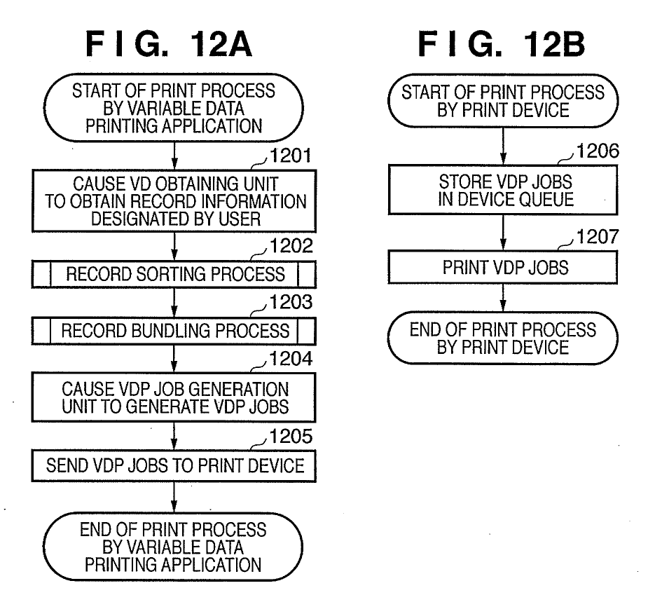

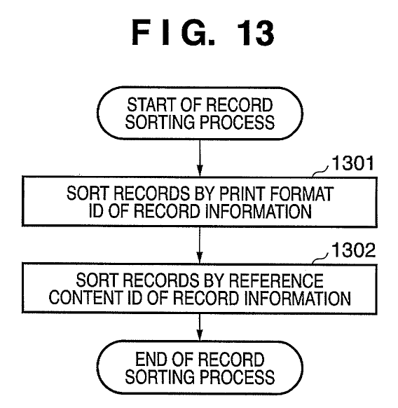

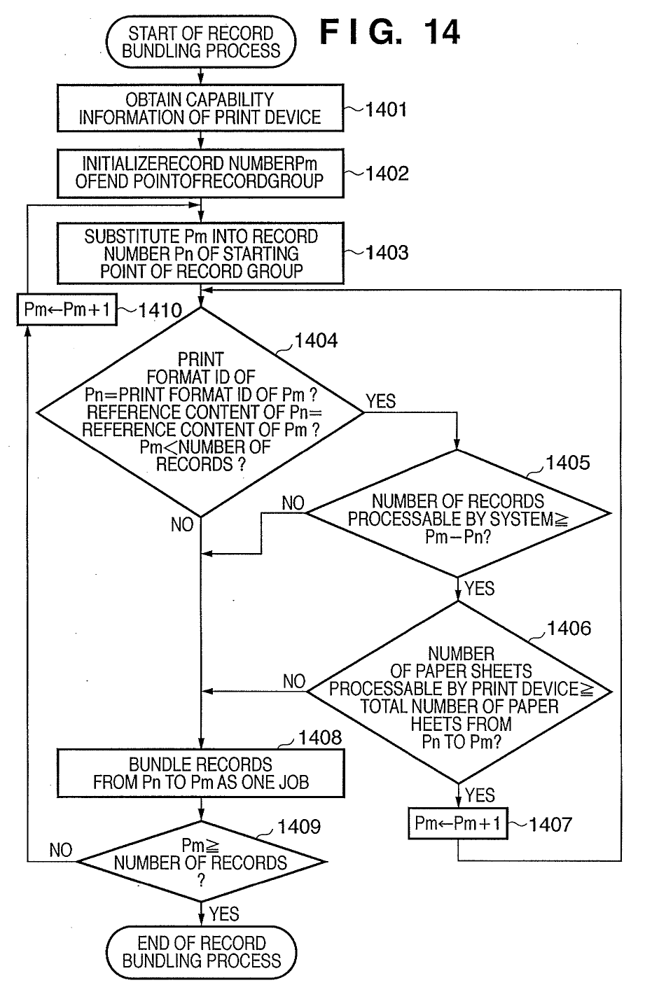

FIGS. 12A and 12B are flowcharts illustrating the print process of the variable printing system according to the second embodiment. In step 1201, the VD obtaining unit 1105 obtains records designated by the user from the variable database 1102. In step 1202, the VD obtaining unit 1105 sorts record information obtained in step 1201. This will be described later with reference to FIG. 13. In step 1203, the VD obtaining unit 1105 bundles the records sorted in step 1202. This will be described later with reference to FIG. 14. In step 1204, the VDP job generation unit 1107 generates a VDP job for each record group bundled in step 1203. In step 1205, the VDP job sending unit 1108 sends the VDP jobs to the print device 1104.

In step 1206, the VDP job receiving unit 1112 of the print device 1104 stores the received VDP jobs in the device queue 1113. In step 1207, the VDP job printing unit 1114 of the print device 1104 prints the VDP jobs stored in the device queue 1113.

(Record Sorting Process)

FIG. 13 is a flowchart illustrating the record sorting process 1202 in FIG. 12A. In step 1301, the VD obtaining unit 1105 of the variable data printing application 1101 sorts the records using a field representing the print format ID of each record as a key. In step 1302, the VD obtaining unit 1105 sorts, in the record information sorted in step 1301, each record group having the same print format ID using a field representing the reference content ID of each record as a key.

(Record Bundling Process)

FIG. 14 is a flowchart illustrating the record bundling process 1203 in FIG. 12A. In step 1401, the variable data printing application 1101 obtains the processing capability information of the print device 1104. In step 1402, the VD obtaining unit 1105 initializes a variable Pm by substituting 1 into it. The variable Pm represents the record number of the end point of a record group bundled as one VDP job. In step 1403, the VD obtaining unit 0105 substitutes Pm into a variable Pn representing the record number of the starting point of the record group bundled as one VDP job. In step 1404, the VD obtaining unit 0105 refers to the properties of two records and determines whether they are identical in order to process records having the same print format ID and referring to the same content as one job. The VD obtaining unit 1105 also compares the information of the record Pn with that of the record Pm in step 1404. If the records Pm and Pn have the same print format ID and same reference content information, and Pm is smaller than the number of records to be printed, the process advances to step 1405. If the records Pm and Pn have different print format IDs or different reference contents, or Pm is equal to or larger than the number of records to be printed, the process advances to step 1408 because no record cannot be bundled any more.

In step 1405, the VD obtaining unit 1105 determines whether the number (Pm−Pn) of records to be bundled exceeds the number of records processable by the print system. If the number of records to be bundled exceeds the number of processable records, the process advances to step 1408 because no record can be bundled any more. If the number of records to be bundled does not exceed the number of processable records, the process advances to step 1406. In step 1406, the VD obtaining unit 1105 obtains the number of copies processable by the device at once (or the number of paper sheets processable per copy) from the processing capability information of the device obtained in step 1401. If the total number of printing paper sheets of the records to be bundled exceeds the tolerance of the print device or post-processing device, the process advances to step 1408 because no record can be bundled any more. If the total number of printing paper sheets does not exceed the tolerance, the process advances to step 1407. In step 1407, the VD obtaining unit 1105 increments Pm by one and refers to the next record.

In step 1408, the VD obtaining unit 1105 bundles the records from the record Pn to record Pm to generate one job. In step 1409, the VD obtaining unit 1105 determines whether Pm is equal to or larger than the number of records to be printed. If Pm is equal to or larger than the number of records to be printed, the record bundling process is ended because all records are already bundled. If Pm is smaller than the number of records to be printed, the process advances to step 1410. In step 1410, the VD obtaining unit 1105 increments Pm by one.

This procedure enables the bundling of records having the same reference content and same print format.

<Job Receiving Process>

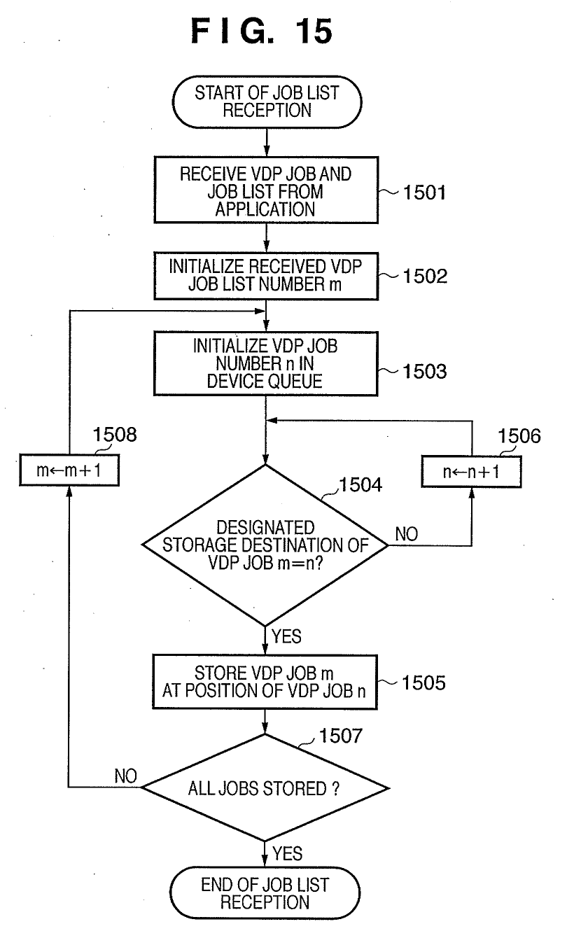

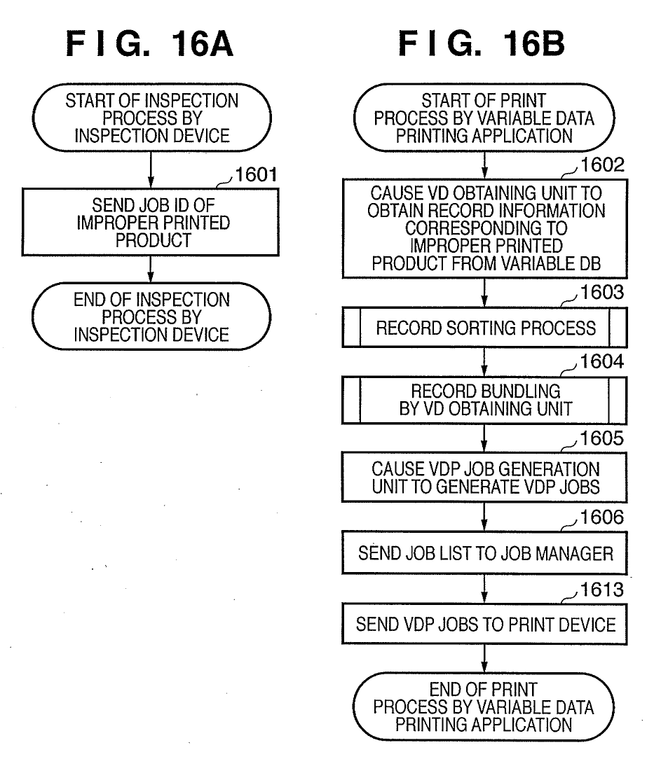

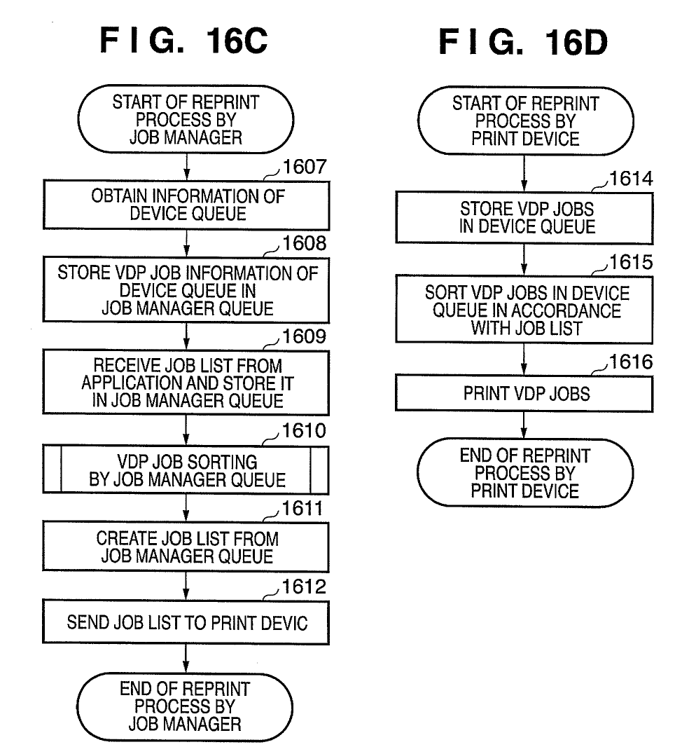

FIG. 15 is a flowchart illustrating a job list receiving process in the VDP job receiving unit 1112 of the print device 1104. The process shown in FIG. 15 is executed upon receiving a job list sent in step 1606 of a reprint process (FIG. 16B).

In step 1501, the VDP job receiving unit 1112 receives VDP jobs and a job list from the variable data printing application 1101. In step 1502, the VDP job receiving unit 1112 initializes a variable m representing a VDP number in the received job list to 0. In step 1503, the VDP job receiving unit 1112 initializes a variable n representing a VDP job number in the device queue 1113 to m.

In step 1502, the VDP job receiving unit 1112 compares the storage destination number of a job ID designated in the job list with the job number in the device queue 1113. If the storage destination number matches the job number, the process advances to step 1503. If the storage destination number does not match the job number, the process advances to step 1504. In step 1504, the VDP job receiving unit 1112 determines whether the designated device queue storage destination of the VDP job m described in the job list matches n. If the storage destination matches n, n is regarded as the designated position in the device queue 1113, and the process advances to step 1505. If the storage destination does not match n, the process advances to step 1506.

In step 1505, the VDP job receiving unit 1112 stores the VDP job m at the position of the VDP job n in the device queue 1113. In step 1506, the VDP job receiving unit 1112 increments n by one and determines the next VDP job number in the device queue 1113. In step 1507, the VDP job receiving unit 1112 determines whether all received VDP jobs are stored in the device queue 1113. If storage is not completed, the process advances to step 1508. If storage is completed, the receiving process is ended. In step 1508, the VDP job receiving unit 1112 increments m by one to search for the position of the next VDP job on the job list.

In the above-described way, the print device arranges the VDP jobs in the device queue in accordance with the received job list.

<Reprint Process>

(Variable Data Printing Application)

FIGS. 16A, 16B, 16C, and 16D are flowcharts illustrating the reprint process of the print and bookbinding system according to the second embodiment. In step 1601 in FIG. 16A, the detection unit 1116 of the inspection device 1115 finds an improper printed product, and the result notification unit 1117 notifies the variable data printing application 1101 of the job ID of the printed product. Note that “improper” here indicates that a printed product does not comply with the user's intention, i.e., a print error exists.

In step 1602 in FIG. 16B, the VD obtaining unit 1105 of the variable data printing application 1101 obtains, from the variable database 1102, a record corresponding to the improper VDP job ID received in step 1601. In step 1603, the VD obtaining unit 1105 sorts the record information obtained in step 1602. This process is executed in accordance with the procedure in FIG. 13. In step 1604, the VD obtaining unit 1105 bundles the records sorted in step 1603. In step 1605, the VDP job generation unit 1107 generates a VDP job for each record group bundled in step 1604. In step 1606, the VDP job sending unit sends a job list to the job manager queue control unit 1109 of the job manager 1103. The job list includes information about each job sent from the variable data printing application 1101.

(Job Manager)

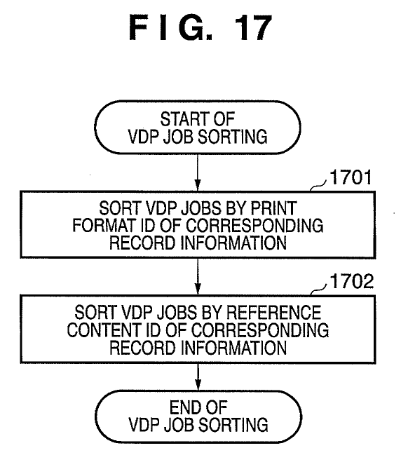

The job manager starts a process from step 1607 upon receiving, in step 1606, job information from the variable data printing application which functions as a print data generation device. In step 1607 in FIG. 16C, the device queue information obtaining unit 1110 of the job manager 1103 obtains the VDP job information of the device queue 1113. In step 1608, the device queue information obtaining unit 1110 stores, in the job manager queue 1111, the VDP job information of the device queue 1113 obtained in step 1607. In step 1609, the job manager queue control unit 1109 stores, in the job manager queue 1111, the job list sent in step 1606. In step 1610, the job manager queue 1111 sorts all pieces of stored VDP job information using, as a key, the record information referred upon generating each VDP job. This will be described later with reference to FIG. 17. In step 1611, the job manager queue 1111 creates a job list using the order of VDP jobs sorted in the queue. In step 1612, the job manager queue 1111 sends the job list to the print device 1104.

When notified of the job list sending by the job manager, the variable data printing application 1101 executes step 1613. In step 1613, the VDP job sending unit 1108 sends the VDP jobs to the print device 1104.

(Print Device)

In step 1614 in FIG. 16D, the VDP job receiving unit 1112 of the print device 1104 stores the received VDP jobs in the device queue 1113. In step 1615, the device queue 1113 sorts the VDP jobs in the queue in accordance with the job list sent from the job manager in step 1612. In step 1616, the VDP job printing unit 1114 prints the VDP jobs stored in the device queue 1113.

<VDP Job Sorting Process>

FIG. 17 is a flowchart illustrating the VDP job sorting process 1610 in FIG. 16C.

VDP job sorting will be described below. In step 1701, the job manager queue 1111 sorts the VDP jobs in the queue using, as a key, a print format ID contained in the record information upon generating each VDP job. The process in step 1701 will be described here in detail. Before the process in step 1701, the job manager queue 1111 holds the job information of the device queue and the job list. The job manager queue 1111 cannot recognize, for example, the print format ID of a record included in each job from the job information of the device queue. However, the job list sent in step 1608 contains the record information (including the print format ID) of each record. Hence, the job manager queue 1111 can recognize the print format ID of each job information of the device queue by using the job list. It is therefore possible to sort the jobs. In step 1702, the job manager queue 1111 sorts the jobs sorted in step 1701 using, as a key, reference content information contained in the record information of each VDP job.

The above-described procedure registers the VDP jobs to be reprinted in the device queue. In the second embodiment, the variable data printing application does not control reprint. Hence, the variable data printing application need only execute the same procedure as before except sending a job list to the job manager. This increases the independence of the manager for controlling reprint and facilitates software creation and maintenance.

### Other Embodiments

In the above-described embodiments, a computer copies the job sequence in the device queue. However, when a host computer stores the sequence of jobs sent to the device and obtains, from the device, information representing a job currently under processing, the device queue can be reproduced in the host computer.

The present invention is also applicable to a system including a plurality of devices (e.g., host computer, interface device, reader, and printer) or an apparatus (e.g., copying machine or facsimile apparatus) including a single device. The object of the present invention is achieved even by supplying a recording medium which records program codes for implementing the functions of the above-described embodiments to the system or apparatus and causing the computer of the system or apparatus to read out and execute the program codes stored in the storage medium. In this case, the program codes read out from the storage medium implement the functions of the above-described embodiments by themselves, and the program codes themselves and the storage medium which stores the program codes constitute the present invention.

The present invention also incorporates a case in which the functions of the above-described embodiments are implemented when an operating system (OS) running on the computer partially executes actual processing, or an interface process is executed on the basis of the instructions of the program codes. The present invention is also applicable to a case in which the program codes read out from the storage medium are written in the memory of a function expansion card inserted into the computer or a function expansion unit connected to the computer. In this case, the CPU of the function expansion card or function expansion unit partially or wholly executes actual processing on the basis of the instructions of the written program codes, thereby implementing the functions of the above-described embodiments.

When the present invention is applied to the storage medium, it stores program codes corresponding to the above-described flowcharts shown in FIGS. 3A, 3B, 3C, 4A, 4B, 9, 10A, 10B, 10C, 12A, 12B, 13, 14, 15, 16A, 16B, 16C, 16D, and 17.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-146102, filed May 31, 2007 which is hereby incorporated by reference herein in its entirety.

What is claimed is:

1. An information processing apparatus connected to a print device for processing a print job, comprising:
a job sender which sends, to the print device, print jobs generated from different variable data in an order of sorting the different variable data using a designated sort key; and
a determiner which, in sending an additional print job to be added to the sent print jobs, determines ordinal information for specifying a processing order of the additional print job using information representing a processing order of the print jobs sent by said job sender and information of the additional print job,
wherein said job sender sends, to the print device, the additional print job and the ordinal information determined by said determiner.

2. The apparatus according to claim 1, wherein the ordinal information represents a position where the additional print job should be stored in a device queue when the print device sorts the plurality of print jobs, including the additional print job, stored in the device queue.

3. The apparatus according to claim 1, further comprising an obtainer which obtains, from the print device, information representing the processing order of the print jobs registered in a device queue,
wherein said determiner determines the ordinal information for specifying the processing order of the additional print job using the information of the additional print job in addition to the information representing the processing order of the print jobs obtained by said obtainer.

4. The apparatus according to claim 1, wherein upon receiving reprint information representing necessity of reprint of a printed product printed by the print device, said job sender sends, to the print device, a print job corresponding to identification information of a job having the necessity of reprint as the additional print job.

5. The apparatus according to claim 1, further comprising:
a sorter which sorts the variable data based on the designated sort key; and
a job generator which generates a print job using, of the plurality of variable data sorted by said sorter, variable data having the same information about the sort key.

6. The apparatus according to claim 1, wherein the apparatus receives a print job from a print data generation device comprising a sorter which sorts the variable data based on the designated sort key, and a job generator which generates a print job using, of the plurality of variable data sorted by said sorter, variable data having the same information about the sort key.

7. The apparatus according to claim 5, wherein the sort key is one of content information contained in the variable data and print format information set in the variable data.

8. The apparatus according to claim 5, wherein said job generator specifies variable data contained in one print job using the plurality of variable data having the same information about the sort key and a processing capability of the print device, and generates a print job using the specified variable data.

9. An information processing method by an information processing apparatus including a job sender and a determiner and connected to a print device for processing a print job, the method comprising the steps of:
sending, to the print device, print jobs generated from different variable data in an order of sorting the different variable data using a designated sort key; and
in sending an additional print job to be added to the sent print jobs, determining ordinal information for specifying a processing order of the additional print job using information representing a processing order of the print jobs sent in the step of sending and information of the additional print job,
wherein in the step of sending, the additional print job and the ordinal information determined in the step of determining are sent to the print device.

10. The method according to claim 9, wherein the ordinal information represents a position where the additional print job should be stored in a device queue when the print device sorts the plurality of print jobs, including the additional print job, stored in the device queue.

11. The method according to claim 9, further comprising the step of obtaining, from the print device, information representing the processing order of the print jobs registered in a device queue,
wherein in the step of determining, the ordinal information for specifying the processing order of the additional print job is determined using the information of the additional print job in addition to the information representing the processing order of the print jobs obtained in the step of obtaining.

12. The method according to claim 9, wherein in the step of sending, upon receiving reprint information representing necessity of reprint of a printed product printed by the print device, a print job corresponding to identification information of a job having the necessity of reprint is sent to the print device as the additional print job.

13. The method according to claim 9, further comprising the steps of:
sorting the variable data based on the designated sort key; and
generating a print job using, of the plurality of variable data sorted in the step of sorting, variable data having the same information about the sort key.

14. The method according to claim 9, further comprising the step of receiving a print job from a print data generation device comprising a sorter which sorts the variable data based on the designated sort key, and a job generator which generates a print job using, of the plurality of variable data sorted by the sorter, variable data having the same information about the sort key.

15. The method according to claim 13, wherein the sort key is one of content information contained in the variable data and print format information set in the variable data.

16. The method according to claim 13, wherein in the step of generating, variable data contained in one print job is specified using the plurality of variable data having the same information about the sort key and a processing capability of the print device, and a print job is generated using the specified variable data.

17. A program stored in a computer-readable storage medium and executed by a computer connected to a print device for processing a print job, the program causing the computer to function as;
a job sender which sends, to the print device, print jobs generated from different variable data in an order of sorting the different variable data using a designated sort key; and
a determiner which, in sending an additional print job to be added to the sent print jobs, determines ordinal information for specifying a processing order of the additional print job using information representing a processing order of the print jobs sent by said job sender and information of the additional print job,
wherein said job sender sends, to the print device, the additional print job and the ordinal information determined by said determiner.

18. The program according to claim 17, wherein the ordinal information represents a position where the additional print job should be stored in a device queue when the print device sorts the plurality of print jobs, including the additional print job, stored in the device queue.

19. The program according to claim 17, further causing the computer to function as an obtainer which obtains, from the print device, information representing the processing order of the print jobs registered in a device queue,
wherein said determiner determines the ordinal information for specifying the processing order of the additional print job using the information of the additional print job in addition to the information representing the processing order of the print jobs obtained by said obtainer.

20. The program according to claim 17, wherein upon receiving reprint information representing necessity of reprint of a printed product printed by the print device, said job sender sends, to the print device, a print job corresponding to identification information of a job having the necessity of reprint as the additional print job.

21. The program according to claim 17, further causing the computer to function as:
a sorter which sorts the variable data based on the designated sort key; and
a job generator which generates a print job using, of the plurality of variable data sorted by said sorter, variable data having the same information about the sort key.

22. The program according to claim 17, further causing the computer to function to receive a print job from a print data generation device comprising a sorter which sorts the variable data based on the designated sort key, and a job generator which generates a print job using, of the plurality of variable data sorted by said sorter, variable data having the same information about the sort key.

23. The program according to claim 21, wherein the sort key is one of content information contained in the variable data and print format information set in the variable data.

24. The program according to claim 21, wherein said job generator specifies variable data contained in one print job using the plurality of variable data having the same information about the sort key and a processing capability of the print device, and generates a print job using the specified variable data.

25. A print system comprising:
an information processing apparatus including:
a job sender which sends, to the print device, print jobs generated from different variable data in an order of sorting the different variable data using a designated sort key; and
a determiner which, in sending an additional print job to be added to the sent print jobs, determines ordinal information for specifying a processing order of the additional print job using information representing a processing order of the print jobs sent by said job sender and information of the additional print job,
said job sender sending, to the print device, the additional print job and the ordinal information determined by said determiner, and
a print device which receives and processes a print job sent from said information processing apparatus.
